(19) United States
(12) Patent Application Publication
(10) Pub. No.: US 2011/0258119 A1
(43) Pub. Date: Oct. 20, 2011

(54) DIGITAL CHECK TRANSACTION SYSTEM

(75) Inventor: Tolga AL, Istanbul (TR)

(73) Assignee: Techone Telekomunikasyon Iletisim Yazilim Danismanlik ve Pazarlama Ticaret LDT STI, Istanbul (TR)

(21) Appl. No.: 13/086,816

(22) Filed: Apr. 14, 2011

Related U.S. Application Data
(60) Provisional application No. 61/351,491, filed on Jun. 4, 2010.

(30) Foreign Application Priority Data
Apr. 14, 2010 (TR) 2010/02917

(51) Int. Cl. G06Q 40/00

(52) U.S. Cl. 705/44

(57) ABSTRACT

A digital check transaction system including a receiver which receives, from a requestor, a request for confirming whether a check can be endorsed to a recipient to complete a transaction between the requestor and the recipient, a processor which processes the received request to determine whether the check can be endorsed, and a transmitter which, in response to the processor determining whether the check can be endorsed, transmits a response to the requestor indicating whether the check can be endorsed.

### CROSS-REFERENCE TO RELATED PATENT APPLICATION

This application claims the benefit of copending Turkish Patent Application No. 2010/02917 filed Apr. 14, 2010 and copending U.S. Provisional Application Ser. No. 61/351,491 filed on Jun. 4, 2010, the disclosures of which is incorporated herein in its entirety by reference.

### BACKGROUND

1. Field

Methods and apparatuses consistent with exemplary embodiments relate to digital check transactions, and more particularly, to methods and apparatuses for processing on-demand requests for endorsing a check to complete a check transaction between a requestor and a recipient.

2. Description of the Related Art

One of the problems associated with transactions involving checks is the illegal use of such checks when sufficient amounts are unavailable in a bank account belonging to the endorser of the check. Another problem is the fraudulent copying of checks. Therefore, there is a need to prevent illegal use of checks and protect the recipient (e.g., a person or a corporation) of such illegal checks.

### SUMMARY

One or more exemplary embodiments provide a digital check transaction system and a digital check transaction method for preventing invalid checks by blocking the transaction amount upon demand in the bank account of the party or parties involved in the transaction. Another objective is to prevent illegal use of checks and to prevent fraudulent copying of checks, and protect the parties to which the check was transferred. Yet another objective is to relieve the judiciary courts from trials due to check fraud and to enable governments to control the circulation of all checks besides the ones in exchange. Another objective is to prevent economic casualties to the parties involved in the transaction due to invalid/fake checks, thereby preventing the loss of taxation.

According to an exemplary embodiment, there is provided a digital check transaction system including a receiver which receives, from a requestor, a request for confirming whether a check can be endorsed to a recipient to complete a transaction between the requestor and the recipient, a processor which processes the received request to determine whether the check can be endorsed, and a transmitter which, in response to the processor determining whether the check can be endorsed, transmits a response to the requestor indicating whether the check can be endorsed.

According to another exemplary embodiment, there is provided a digital check transaction method including receiving, from a requestor, a request for confirming whether a check can be endorsed to a recipient to complete a transaction between the requestor and the recipient, processing the received request to determine whether the check can be endorsed, and transmitting, in response to the processor determining whether the check can be endorsed, a response to the requestor indicating whether the check can be endorsed.

### BRIEF DESCRIPTION OF THE DRAWINGS

The above and other features and advantages will become more apparent by describing in detail exemplary embodiments thereof with reference to the attached drawings in which:

FIG. 1 is a flowchart illustrating the process of endorsing a check according to an exemplary embodiment; and

FIG. 2 is a flowchart illustrating the process of starting the endorsement of a check online according to an exemplary embodiment.

### DETAILED DESCRIPTION OF EXEMPLARY EMBODIMENTS

Hereinafter, exemplary embodiments will be described more fully with reference to the accompanying drawings.

There are two ways to access the digital check system. One way is through short message service (SMS) and the other is via the web site provided by the institution in charge (e.g., a bank).

Interactive SMS System

In a non-limiting embodiment, the interactive SMS system accepts messages of the following form:

<COMMAND> <PARAMETERS>

where parameters are separated by blank character.

The message to fill in a check (first transfer) can be in the following format:

TRANSFER <FIN. INST. ID&CHECK ID> <RECEIVER ID> <AMOUNT> <DAY>

The parameters are arranged in the order of necessity, however the order may be modified. Here ‘TRANSFER’ is a reserved word to specify the command.

### DEFINITIONS

<COMMAND> Command, as in command line systems, specifies the type of task in the digital check transaction system. The command set contains but is not limited to the following (which are the core commands): “TRANSFER”, “LIST”, and “CONFIRM”.

The TRANSFER command initiates a check transfer transaction. After mutual confirmation using CONFIRM commands (the user, i.e., the requestor, is directed a message to respond for confirmation or rejection), the transfer is successfully completed.

The LIST command lists the checks belonging (either directly or by means of a transfer) to the requesting user.

<FIN. INST. ID> This parameter identifies the financial institution from which the check was taken. This parameter can be useful if it is determined that the transfer needs to be escalated to an intermediate institution such as Exchange Bank.

<CHECK ID> CHECK ID is the string which uniquely identifies a check. It is possible to create over 60 million unique ids with 5 alphanumeric chars. The length of this string can be decided according to the estimate number of potential users and is not limited to a certain number of characters or a certain type of characters.

By placing a country code just before the financial institution id parameter, it is possible to make the check identifier universal like an International Bank Account Number (IBAN).

<RECEIVER ID> This parameter is the user code of the receiver or recipient of the check. This should be a unique number which functionally determines the receiver such as an identity number or a social security number (SSN) for a person; or a tax number for a corporation. This can also be a unique number which is given by the authority in charge. For example a unique alphanumeric string of length 6 can be used to identify users. In such a case, the first digit could serve to distinguish personal users from corporate users.

<AMOUNT> This parameter identifies the amount of money to transfer. If not specified the default currency is the currency of the country in which the transaction is occurring. For instance, in a Turkish financial system 1000 would mean 1000 Turkish Lira and in the United States the same 1000 would mean 1000 dollars.

For daily checks it is possible to negotiate with the bank account, determine whether the check is valid, and if so block the amount from the check issuer's bank account or else rollback the transaction. When the system blocks the amount both parties could be informed about the situation. Therefore the problem of invalid checks (i.e., the checks with no due money in the subject bank account) could be resolved.

<DAY> In countries such as Turkey the due date of the check (starting from the current date) can be determined by this parameter (i.e., this parameter can identify the desired date of the check transaction). For daily checks this parameter does not have to be used.

In order to re transfer an already filled check the user enters a message in the following form:

TRANSFER <FIN. INST. ID> <CHECK ID> <RECEIVER ID>

Notice that the amount and day parameter, which determine the due date are not given since they are already specified.

SMS Number

The SMS messages to access the digital check transaction system will be sent to a specific short number (4 digits in one exemplary embodiment) which is provided by telecommunication providers such as a GSM operator. The messages sent to this number shall be interpreted based on the received command(s) included in the message and upon necessity the system will interact with other information systems for completion of the transaction.

The SMS based check confirmation mechanism will use the check book, GSM number associated with the user, and a password (one time password if required) to confirm the validity of a check. Losing all of the requirements at the same time is almost impossible. When a security component is lost and checks are at risk then the user will have an option to block the operations on checks belonging to him over internet or telephone or by any other means that would be obvious to a person of ordinary skill in the art.

Usage Illustrations

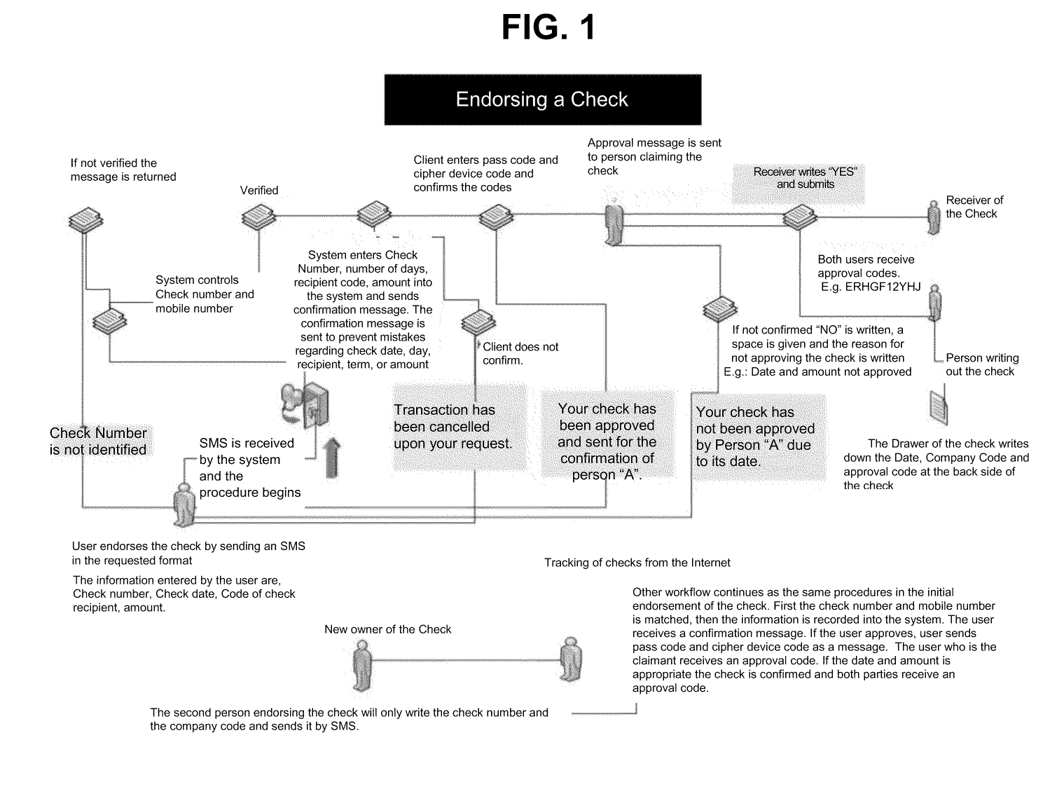

FIG. 1 is a flowchart illustrating the process of endorsing a check according to an exemplary embodiment. As shown in FIG. 1, in order to initiate a fill in transaction, the first owner enters the “TRANSFER” command as stated above. For illustration let's assume the financial institution and check ID is coded together as “22AB001”, the receiver id is “VAB001”, the amount to transfer is “5270.87”, and it will be paid after 22 days.

Recall the format:

TRANSFER <FIN. INST. ID&CHECK ID> <RECEIVER ID> <AMOUNT> <DAY>

Then the check owner writes an SMS as

TRANSFER 22AB001 VAB001 5270,87 22

A confirmation message is sent to user in order to prevent mistakes. For example:

CNO:22AB001,Receiver:XXXXX,AMOUNT:FIVETHOUSANDTWOHUNDREDSEVENTY$87CENT, DUE DATE:XX/XX/XXXX CONFIRMATION PLEASE

This message is sent to the sender himself for primary confirmation. The user (i.e., the sender) enters the confirmation command “CONFIRM” followed by the check id (“22AB001” in our case) and user/operation password and the confirmation or rejection parameter “YES” or “NO”. It is possible to implement a timeout mechanism to cancel the transfer if the user does not confirm within a specified time.

The confirmation message is an illustration and its content may be changed by the company who implements the system. The format of response and the example is as follows.

CONFIRM <FIN. INST. ID&CHECK ID> <PASSWORD> <{OK,CANCEL}>

CONFIRM 22AB001<PASSWORD> OK

The user checks the amount, due date, the receiver ID, and if any information is incorrect then he/she can cancel the operation by the same command ending with CANCEL.

Ex:

CONFIRM 22AB001<PASSWORD> CANCEL

The reserved words for approval/rejection may be changed to YES/NO or something else by either the financial/governmental institution or the software vendor.

Then the receiver gets a confirmation request.

Ex:

CNO:22AB001,Sender:XXXXX,AMOUNT:FIVETHOUSANDTWOHUNDREDSEVENTY$87CENT, DUE DATE:XX/XX/XXXX CONFIRMATION PLEASE

The receiver responds in a similar format that the sender uses except that there is no need for a password to proceed with the confirmation. An example of a format and the message to send in this case:

CONFIRM <FIN. INST. ID&CHECK ID> <OK COMMAND>

CONFIRM 22AB001 OK

If the receiver wants to reject the transfer then he/she may respond giving a reason at the end of the message.

For example:

CONFIRM <FIN. INST. ID&CHECK ID> <CANCEL COMMAND> <REASON>

ONAY 22AB001 CANCEL DATE

This command means that the receiver rejects the transfer due to a problem in date. This information delivered to the sender to allow him to provide feedback and correct the mistake.

The feedback message:

TRANSFER OF CNO 22AB001 WAS REJECTED DUE TO DATE

If the receiver accepts the transfer then both the receiver and the sender get a message containing a transfer confirmation number or a transfer confirmation code.

For example:

CNO:22AB001 CONFIRM NO:ABC12CD34

The sender writes the confirmation code and the date on the check physically and delivers it to receiver.

Re-Transferring a Check

As noted earlier, when a check is filled in it no longer requires amount and date to be specified. So the re-transfer only requires the check number and the receiver ID.

In the above example: TRANSFER 22AB001 VAB001

The rest of the process is the same with the first transfer transaction.

Case when More than One Confirmation is Needed

Some corporations require multiple confirmations before a check can be authorized. In this case all corresponding users are required to confirm. Upon completion, all people involved are informed about the result.

Option of Due Date Extension

Upon necessity, the person/corporation who wants to extend the due date sends a request message to the digital check transaction system. The transaction is committed if it is confirmed by the receiver party.

The message format and an example is:

EXTEND <FIN. INST. ID&CHECK ID> <DAYS EXTENDED>

EXTEND 22AB001 10

A message containing confirmation is sent to the final receiver.

10 Days Extension is Requested for Check No 22AB001.

This message can be modified to give more information such as an identifier of the requesting user, the amount, and due date of the check. The confirmation message is the same as confirming a transfer.

Option of Back Transfer

The user may want to return the good/product for which the transaction was made and receive the check back. In such a case the check can re-transferred back to the user. The user requests a back transfer to the receiving party with a message in the following format in one exemplary embodiment:

BACKTRANS <FIN. INST. ID&CHECK ID> <RECEIVER ID>

Ex: BACKTRANS 22AB001 VAB001

If the final receiver (current owner) of the check confirms the transaction is reversed, this information is recorded in the database and the check is transferred back to the requesting user.

Web Interface

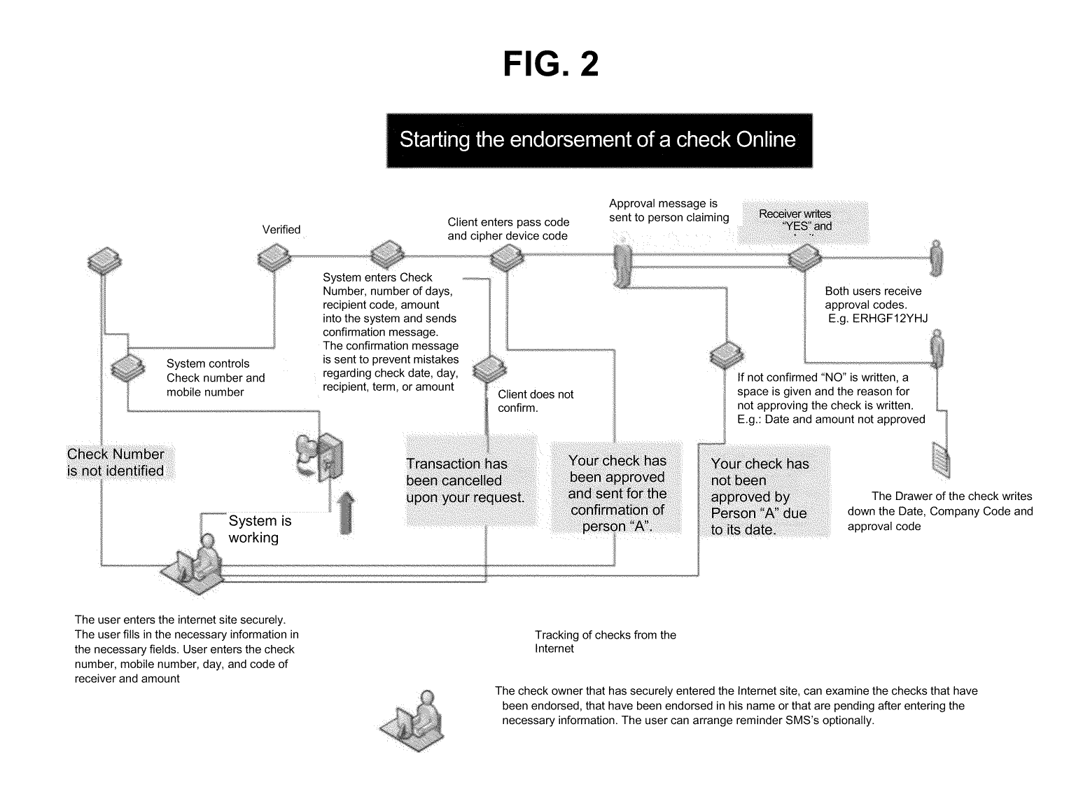

FIG. 2 is a flowchart illustrating the process of starting the endorsement of a check online according to an exemplary embodiment. As shown in FIG. 2, the digital check transaction system may also be accessed via a secure web interface provided by the governmental/financial institution in charge. Besides all interactive SMS based processes, user will be able to query checks related to him/her and set SMS or mail reminders for checks due to be paid. So the user will have an alternative option to carry out SMS enabled processes such as a confirmation process.

Other Issues

Daily Check Transfer Limit

Depending on a user's choice, the transfer amount per day can be limited.

Defining Financial Accounts Related with a User

Financial institution accounts related with a user may be defined in order to automatically transfer the amount to a receiving party. When the user does not have an account in a bank which provides the check concerned then the check is directed to an intermediate bank (, e.g., an Exchange Bank). The digital check transaction system can decide whether the check is directly transferable or it requires involvement of an Exchange Bank.

Defining an Exchange Account Related with User

In an automated system, when a check requires the involvement of an Exchange Bank in view of the conditions discussed above, then the user can specify a bank account to be used in this case.

Defining Checks in The System

The state or the institution in charge will deliver unique user codes for each person and corporation and relate a number (e.g., a GSM number) with each user account. If the user is only a receiver of checks, such a user does not need to own a check book and thus this user does not need a one-time-password (OTP) as this password is only required when confirming a transfer of funds to others. The checks will be defined in the system via an integration interface provided by the institution in charge to financial institutions. The bank who delivers the check book to a user will make a provisioning in the central system. In one embodiment, users will not be able to insert or delete a check in the database.

Writing the Confirmation Code on the Check

As discussed above, after all confirmations are done a confirmation code is delivered to all parties involved in the transaction/process. At this point, the sending party can write his/her user id, the date of transaction, and the confirmation code on the back of the check. Regulation can be promulgated by the government or institution in charge for the information to write on the back of the check. Moreover, even when more than one signature is required, since all parties have confirmed only one signature could be sufficient.

Working without a Check Book

In one exemplary embodiment, it is possible to process checks completely in digital manner. Instead of delivering a physical check book, the financial contact of a company receives only the credentials of access to corporate checks in the system. The user remains liable as long as he/she has the requisite credentials.

What is claimed is:

1. A digital check transaction system comprising:
a receiver which receives, from a requestor, a request for confirming whether a check can be endorsed to a recipient to complete a transaction between the requestor and the recipient;
a processor which processes the received request to determine whether the check can be endorsed; and
a transmitter which, in response to the processor determining whether the check can be endorsed, transmits a response to the requestor indicating whether the check can be endorsed.

2. The digital check transaction system of claim 1, wherein the request is a text message request received via a mobile device.

3. The digital check transaction system of claim 2, wherein the received request comprises a bank identifier, a check identifier, a recipient identifier identifying the recipient, a transfer amount, and desired date of the transaction.

4. The digital check transaction system of claim 3, wherein the processor, in response to processing the request and prior to determining whether the check can be endorsed, transmits a first confirmation request to the requestor to confirm that contents of the request processed by the processor are accurate.

5. The digital check transaction system of claim 4, wherein the processor receives a first message from the requestor in response to the first confirmation request, and if the requestor confirms in the first message that the contents of the request processed by the processor are accurate, the processor determines whether the check can be endorsed to the recipient.

6. The digital check transaction system of claim 5, wherein the processor, in response to determining that the check can be endorsed to the recipient, transmits a second confirmation request to the recipient to confirm that contents of the request processed by the processor are acceptable to the recipient.

7. The digital check transaction system of claim 6, wherein the processor receives a second message from the recipient in response to the second confirmation request, and if the recipient confirms in the message that the contents of the request processed by the processor are acceptable, the processor transmits a confirmation code to the requestor and the recipient so the transaction can be completed.

8. The digital check transaction system of claim 7, wherein in response to receiving the confirmation code, the requestor provides the received confirmation code on the check and delivers the check to the recipient.

9. A digital check transaction method comprising:
receiving, from a requestor, a request for confirming whether a check can be endorsed to a recipient to complete a transaction between the requestor and the recipient;
processing the received request to determine whether the check can be endorsed; and
transmitting, in response to the processor determining whether the check can be endorsed, a response to the requestor indicating whether the check can be endorsed.
